(19) United States
(12) Patent Application Publication
(10) Pub. No.: US 2019/0272058 A1
(43) Pub. Date: Sep. 5, 2019

(54) DISPLAY DEVICE

(71) Applicant: Sharp Kabushiki Kaisha, Sakai City, Osaka (JP)

(72) Inventor: Mikihiro NOMA, Sakai City (JP)

(21) Appl. No.: 16/336,482

(22) PCT Filed: Sep. 25, 2017
(86) PCT No.: PCT/JP2017/034473

§ 371 Date: Mar. 26, 2019

(30) Foreign Application Priority Data
Sep. 30, 2016 (JP) 2016-194555

(51) Int. Cl. G06F 3/041; G06F 1/16; G06F 3/044

(52) U.S. Cl. CPC G06F 3/0412; G06F 3/0443; G06F 1/1643; G06F 3/0414

(57) ABSTRACT

To improve visibility of a display surface in a display module capable of vibrating, the display module (1) includes: a display module (10) including a touch sensor; and a first housing (20) accommodating the display module (10), the display module (10) being provided with a vibrating element (15) and being movably attached to the first housing (20).

### TECHNICAL FIELD

The present invention relates to a display device.

### BACKGROUND ART

Patent Literature 1 discloses a conventional technique which relates to a display device including a touch panel. This display device causes the touch panel to bend and vibrate in response to an operator's operation on the touch panel, so as to feed back an operating feel to the operator's fingertip.

### CITATION LIST

### Patent Literature

[Patent Literature 1]

Japanese Patent Application Publication Tokukaihei No. 2012-190450 (Publication date: Oct. 4, 2012)

### SUMMARY OF INVENTION

### Technical Problem

According to the above conventional technique, the touch panel is spaced from a display section. This spacing forms an air layer, due to which external light incident on the display section from the touch panel side is reflected by an upper surface of the touch panel and an upper surface of the display section. It follows that an amount of the incident light (external light) thus reflected is larger relative to light exiting the display section, and then visibility of a display surface of the display panel is lowered.

### Solution to Problem

A display device in accordance with an aspect of the present invention includes: a display module including a touch sensor; and a first housing accommodating the display module, the display module being provided with a vibrating element and being movably attached to the first housing.

### Advantageous Effects of Invention

According to an aspect of the present invention, it is possible to improve visibility of a display surface of a display module capable of vibrating.

### BRIEF DESCRIPTION OF DRAWINGS

FIG. 1 is a view illustrating a configuration of a display device in accordance with Embodiment 1 of the present invention.

FIG. 2 is a view illustrating a configuration of an in-cell touch panel in accordance with Embodiment 1 of the present invention.

FIG. 3 is a view for explaining an effect of the display device in accordance with Embodiment 1 of the present invention.

FIG. 4 is a view for explaining another effect of the display device in accordance with Embodiment 1 of the present invention.

FIG. 5 is a view illustrating a configuration of a display device in accordance with Embodiment 2 of the present invention.

### DESCRIPTION OF EMBODIMENTS

The following description will discuss several embodiments of the present invention. Note, however, that the following embodiments are illustrative only.

### Embodiment 1

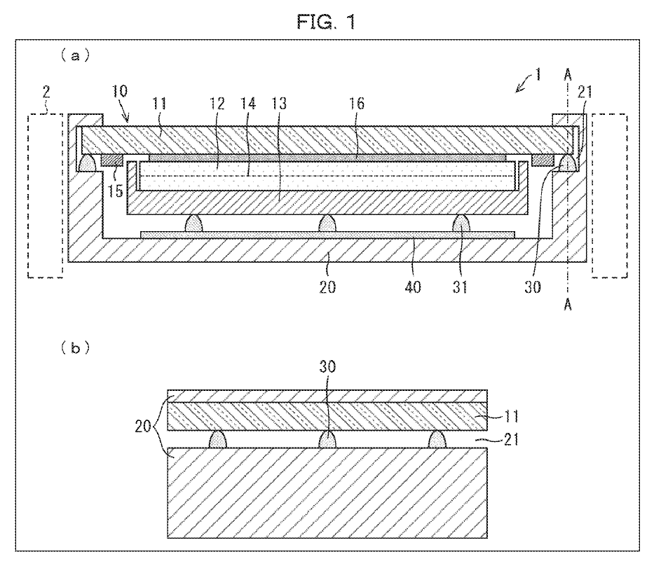

FIG. 1 is a view illustrating a configuration of a display device 1 in accordance with Embodiment 1 of the present invention. (a) of FIG. 1 is a side cross-sectional view of the display device 1. (b) of FIG. 1 is a cross-sectional view of the display device 1 taken along line A-A of (a) of FIG. 1.

The display device 1 in accordance with Embodiment 1 includes a display module 10 including a touch sensor, a first housing 20 accommodating the display module 10, a plurality of first elastic bodies 30 made of resin (first elastic member), and a plurality of second elastic bodies 31 made of resin (second elastic member) (see (a) of FIG. 1). The display module 10 is movably attached to the first housing 20. The display device 1 is assembled into a housing 2 which is securely set outside the display device 1.

The display module 10 includes a cover glass 11 (covering member), a display panel 12, a second housing 13, and a vibrating element 15. The cover glass 11 is adhered, by direct bonding, onto a display surface of the display panel 12 via a transparent adhesive 16.

The display panel 12 is accommodated and secured in the second housing 13. Although not illustrated in (a) of FIG. 1, the second housing 13 also accommodates a backlight unit and a flexible printed circuit board.

The vibrating elements 15 are each provided at an end portion of the cover glass 11 on a rear side (display pane side) of the cover glass 11. The vibrating elements 15 cause the cover glass 11 to vibrate in a vibration pattern which is set in accordance with a vibration signal inputted thereto. The vibrating element 15 can be a piezoelectric element, an actuator, or an eccentric motor.

The first housing 20 has, on its inner surface, a groove 21 into which an edge portion of the cover glass 11 is fitted. At a lower surface of the groove 21, the first elastic bodies 30 are adhered. The individual first elastic bodies 30 also come into contact with the edge portion of the cover glass 11. As illustrated in (b) of FIG. 1, the first elastic bodies 30 are provided at a certain interval in the groove 21. Note that the first elastic body 30 can alternatively be shaped in a continuous manner.

Further, on an inner bottom surface of the first housing 20, a metal layer 40 is provided. The metal layer 40 has the second elastic bodies 31 adhered thereto. The second elastic bodies 31 each come into contact with an outer bottom surface of the second housing 13.

Embodiment 1 assumes that the display module 10 is fixed to at least one of the elastic bodies 30 and the second elastic bodies 31. For example, the cover glass 11 can be adhered to the first elastic bodies 30, and/or the second housing 13 can be adhered, at its bottom portion, to the second elastic bodies 31. In Embodiment 1, an adhered state (i.e., a state in which two members are adhered together) is encompassed by a contact state (i.e., a state in which two members come into contact with each other).

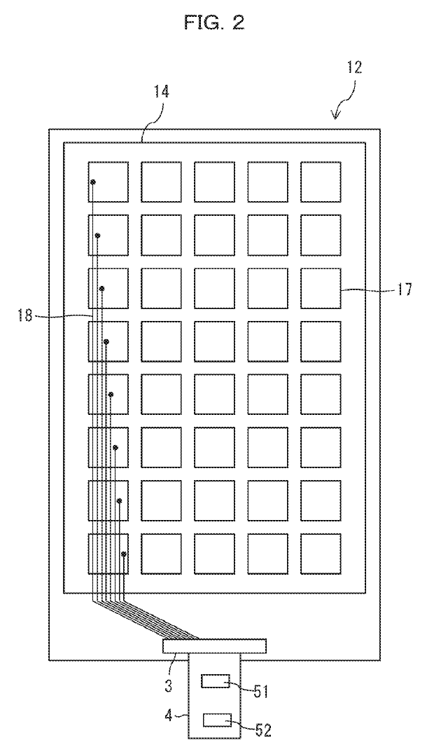

The display panel 12 is an in-cell liquid crystal panel having a touch sensor. The display panel 12 includes a common electrode layer 14 and a pixel electrode, which are provided on an active matrix substrate side. FIG. 2 is a plan view illustrating a configuration of the in-cell liquid crystal panel.

As illustrated in FIG. 2, the common electrode layer 14 of the in-cell liquid crystal panel includes about five- to eight-hundred divided common electrodes 17. The divided common electrodes 17 are arranged at pitches of approximately 4 mm. Each of the divided common electrodes 17 functions as a touch sensor and is connected to a corresponding one of low-resistance metal wirings 18. The individual metal wirings 18 are connected to a driver 3 mounted on the in-cell liquid crystal panel 12.

The driver 3 is connected to a flexible printed circuit board 4. The flexible printed circuit board 4 includes a display control IC 51 and a vibration control IC 52 configured to control vibrations (vibration patterns) of the vibrating elements 15.

The driver 3 conducts liquid crystal panel driving and touch sensor driving in a time-division manner. During the liquid crystal driving, the driver 3 causes all the divided common electrodes 17 to be at the same potential. This allows the divided common electrodes 17 to operate like a single common electrode.

On the other hand, during the touch sensor driving, the driver 3 separately applies voltages to the individual divided common electrodes 17, and then measures parasitic capacitances of the divided common electrodes 17 so as to detect a change in capacitance of the divided common electrodes 17, which change occurs in response to a contact of a user's finger. The divided common electrodes 17, capacitances of which are thus measured independently of each other, function as a sensor group of about five- to eight-hundred sensors. The driver 3 converts a value of the capacitance measured by the sensor group into XY coordinates, and then outputs the XY coordinates to the display control IC 51 and the vibration control IC 52 as a signal indicative of a touch position.

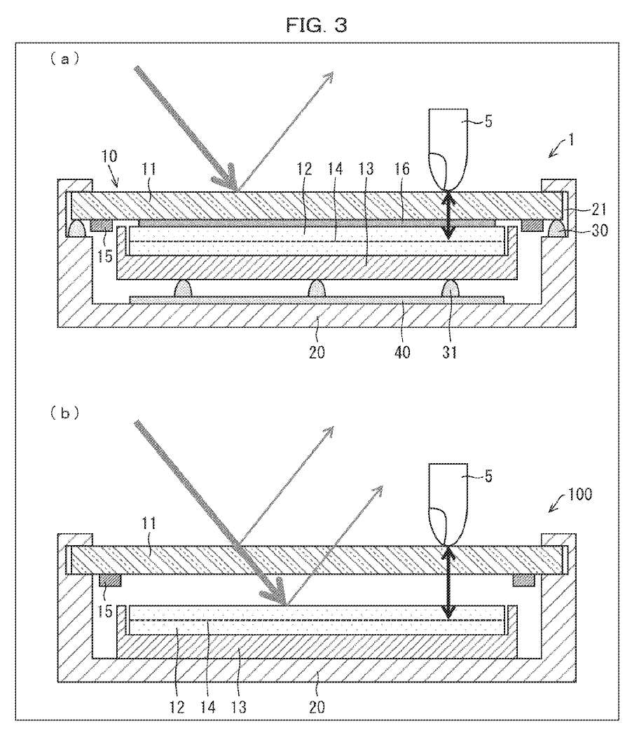

The following description will discuss an effect of the display device 1 in accordance with Embodiment 1, with reference to FIG. 3. FIG. 3 is a cross-sectional view illustrating how external light is incident on the display module of the display device from the cover glass side, and how a user's finger contacts the cover glass. (a) of FIG. 3 illustrates the display device in accordance with Embodiment 1 and (b) of FIG. 3 illustrates a display device in accordance with a comparative embodiment.

One-headed arrows of FIG. 3 indicate external light which is incident on the display module from the cover glass side. The display device 1 has no air layer between the cover glass 11 and the display panel 12, and the cover glass 11 and the display panel 12 are directly bonded via the transparent adhesive 16 (see (a) of FIG. 3). Thus, the external light incident on the display module is reflected only by the upper surface of the cover lass 11 before reaching the display panel 12.

In contrast, a display device 100 of the comparative example has an air layer between the cover glass 11 and the display panel 12 (see (b) of FIG. 3). Thus, the external light incident on the display module is reflected both by the upper surface of the cover glass 11 and by the upper surface of the display panel 12.

As discussed above, the display device 1 does not cause external light to be reflected by the upper surface of the display panel 12. This allows the display device 1 to have a better visibility of its display surface, as compared with the display device 100.

In an illustrated example of FIG. 3, a user's finger 5 contacts the upper surface of the cover glass 11 of the display device 1. In the display device 1, the cover glass 11 and the display panel 12 (in-cell liquid crystal panel) are adhered together by direct bonding (see (a) of FIG. 3). This makes the user's finger 5 close to the common electrode layer 14 (divided common electrodes 17) which functions as the touch sensor. This causes the divided common electrode 17 to largely change its capacitance in response to a contact of the user's finger 5. Thus, it is possible to stably detect the contact of the user's finger 5 with a high degree of accuracy.

In contrast, the display device 100 has an air layer between the cover glass 11 and the display panel 12 (see (b) of FIG. 3). This makes the user's finger 5 apart from the common electrode layer 14. In addition, the air between the cover glass 11 and the display panel 12 has a dielectric constant of nearly 1, which is lower than that of the transparent adhesive 16. Thus, the display device 100 has a smaller change in capacitance of the divided common electrode 17 when the display device 100 is contacted by the user's finger 5, as compared with the display device 1. There is accordingly a possibility that the contact of the user's finger 5 cannot be properly detected.

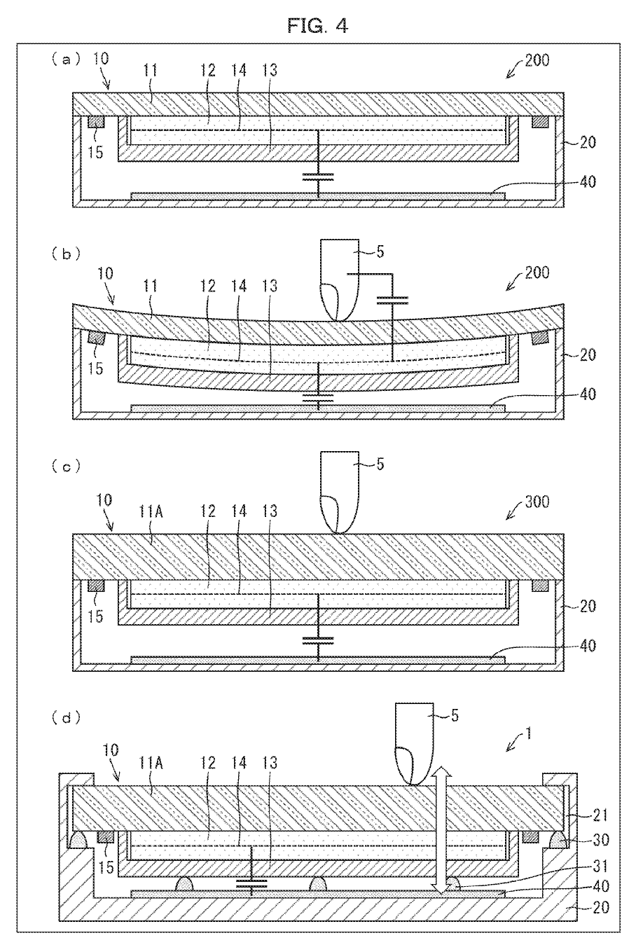

The following description will discuss another effect of the display device 1 in accordance with Embodiment 1 with reference to FIG. 4.

FIG. 4 is a view for explaining how to measure an external pressure applied to the display module 10 of the display device 1, and what effect is produced by this measurement. Note that the transparent adhesive 16 is, albeit not illustrated in FIG. 4, provided between the cover glass 11 and the display panel 12 to adhere these together.

(a) of FIG. 4 is a cross-sectional view illustrating a configuration of a display device 200 in accordance with a comparative example. The display device 200 differs from the display device 1 (see (a) of FIG. 1) in that the groove 21, the first elastic bodies 30, and the second elastic bodies 31 are not provided and the cover glass 11 is fixed to the first housing 20 so as not to move.

(b) of FIG. 4 illustrates how the user's finger 5 applies a pressure to the display module 10 of the display device 200. The pressure is applied from above the cover glass 11 toward the display panel 12. As illustrated in (b) of FIG. 4, the pressure applied to the display module 10 causes the module to warp toward the metal layer 40. This makes the common electrode layer 14 closer to the metal layer 40 and thus, causes a change in capacitance between the divided common electrodes 17 and the metal layer 40. Based on the change in capacitance, it is possible to detect the magnitude of pressure (touch pressure) applied to the cover glass 11. However, in a case where the touch pressure is low, the display module 10 may possibly not warp. In addition, the degree to which the display module warps varies depending on which portion of the cover glass is touched (e.g., a central portion of the display panel easily warps). It therefore follows that detection precision cannot be increased.

According to a display device 300 having a cover glass 11A (see (c) of FIG. 4) thicker than the cover glass 11 of the display device 200, the cover glass 11A of the display device 300, when contacted by the user's finger 5, does not warp due to its high strength. It follows that a touch pressure cannot be detected.

In contrast, according to a display device 1 in accordance with Embodiment 1 which similarly has the thick cover glass 11A (see (d) of FIG. 4), when a pressure is applied by the user's finger 5 to the display module 10 from above the cover glass 11A toward the display panel 12, the cover glass 11A does not warp, but the entire display module 10 can move in a direction indicated by two-headed arrow.

Hence, a pressure applied to the cover glass 11A makes the common electrode layer 14 closer to the metal layer 40 and then, causes a change in capacitance between the common electrode layer 14 and the metal layer 40. Based on the change in capacitance, the magnitude of the pressure (touch pressure) applied to the display module 10 can be detected.

As discussed above, according to the display device 1 in accordance with Embodiment 1, the display module 10 can be moved due to the presence of the first elastic bodies 30 and the second elastic bodies 31 even in a case where the cover glass 11A is too thick to warp. Thus, it is possible to measure the magnitude of pressure (touch pressure). Even in a case where the cover glass 11 is replaced by a covering member made of tempered glass or other such material, which is hard and less likely to deform, it is possible to measure the magnitude of pressure (touch pressure) in a similar manner.

Further, when the display device 1 is touched at the same touch pressure, the entire display module 10 can be moved substantially in the same amount due to the presence of the first elastic bodies 30 and the second elastic bodies 31, regardless of the touch position. This enables accurate detection of the touch pressure. The above effect is further enhanced by using the first elastic bodies 30 and second elastic bodies 31 of the same type.

As described above, the display panel 12 of the display device 1 in accordance with Embodiment 1 allows for detection of a touch position and a touch pressure. For example, during the touch sensor driving, the driver 3 measures potentials of the individual divided common electrodes 17 which are arranged in a matrix as illustrated in FIG. 2. Subsequently, the driver 3 generates a signal indicating a touch position and a signal indicating a touch pressure based on the measured potentials, and then output these signals to the vibration control IC 52 of the flexible printed circuit board 4. By using the received signals, the vibration control IC 52 sets a vibration pattern and outputs a signal (vibration signal) indicating the vibration pattern to the vibrating elements 15. Then, the vibrating elements 15 vibrate in the vibration pattern and in turn, the cover glass 11 vibrates. Such a series of operations allow the display device 1 to feed back to an operator of the display device 1 a vibration pattern appropriate to a contact of the user's finger.

The display device 1 in accordance with Embodiment 1 displays, for example, a virtual button on the display surface of the display panel 12. In a case where the operator contacts the cover glass 11 at a position corresponding to a place where the virtual image is displayed, the vibration control IC 52 sets an appropriate vibration pattern based on the position at which the cover glass 11 is pushed (touch position) and the magnitude of a pressure of the push (touch pressure). Then, the vibrating elements 15 cause the cover glass 11 to vibrate in the vibration pattern thus set, so that the operator can have a comfortable operating feel of, for example, pushing down a button.

As described previously, the display device 1 in accordance with Embodiment 1 employs an in-cell liquid crystal panel as the display panel 12. This makes it possible to achieve not only the display function but also the function of detecting a touch position and a touch pressure and the function of setting a vibration pattern to be fed back. The display module 10 equipped with these functions contributes to reduction in number of components of the display device 1 and also to a simple design.

Further, in a case where the display module 10 is designed to have a relatively small mass, the vibrating elements 15 can be arranged so as to cause the cover glass 11 to vibrate in a vibration pattern into which a certain sound is converted, so that the sound comes out of the cover glass 11. In this way, the cover glass 11 of the display device 1 can also function as an acoustically vibrating speaker).

The display device 1 in accordance with Embodiment 1 can, by measuring a touch pressure as above, feed back to the operator a vibration which allows the operator to feel as if different pushes are made with different pressures. Alternatively, the display device 1 can give the operator a two-step vibration which allows the operator to feel as if the operator is pushing down a button twice. Further, the above touch pressure measurement can be coupled with not only setting of a vibration pattern but also, display of something on a screen of the display panel 12 or output of a sound from the display panel 12 and a desired sound.

The display device 1 in accordance with Embodiment 1 is configured such that the second housing 13 accommodates the backlight unit. However, the present invention is not limited to such a configuration. As an alternative example, the backlight unit can be assembled into the first housing 20 so that backlight from the backlight unit can be projected toward the display panel 12. This configuration can further reduce the mass of the display module 10.

### Embodiment 2

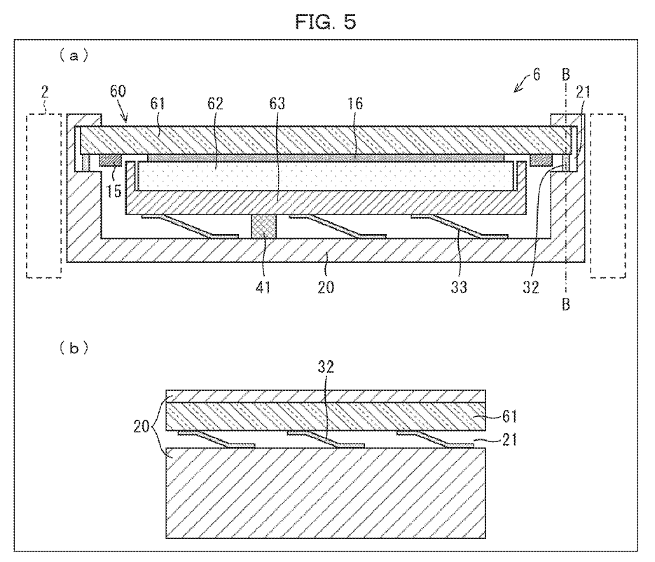

The following description will discuss another embodiment of the present invention with reference to FIG. 5.

FIG. 5 is a view illustrating a configuration of a display device 6 in accordance with Embodiment 2. (a) of FIG. 5 is a side cross-sectional view of the display device 6. (b) of FIG. 5 is a cross-sectional view of the display device 6 taken along line B-B of (a) of FIG. 5.

As illustrated in (a) of FIG. 1, the display device 6 includes a display module 60 including a touch sensor, a first housing 20 accommodating the display module 60, a plurality of first plate springs 32 (first elastic member), a plurality of second plate springs 33 (second elastic member), and a pressure sensor 41. The display module 60 is movably attached to the first housing 20.

The display module 60 includes a cover glass 61 as a covering member, a display panel 62, a second housing 63 accommodating the display panel 62, and a vibrating element 15. The cover glass 61 is adhered, by direct bonding, onto a display surface of the display panel 62 via a transparent adhesive 16.

A difference between the display device 6 in accordance with Embodiment 2 and the display device 1 in accordance with Embodiment 1 is that the cover glass 61 is a touch panel having a touch sensor function, while the display panel 62 is a liquid crystal panel not having a touch sensor function.

Moreover, the display device 6 in accordance with Embodiment 2 includes the first plate springs 32 and the second plate springs 33 as the first elastic member and the second elastic member, respectively. The first plate springs 32 are arranged in a groove 21, which is provided in an inner surface of the first housing 20, so as to be in contact with an edge portion of the cover glass 11 and a lower surface of the groove 21. As illustrated in (b) of FIG. 5, the first plate springs 32 are arranged at a certain interval in the groove 21.

Also, the lower ends of the second plate springs 33 are adhered to an inner bottom surface of the first housing 20, and upper ends of the second plate spring 33 are in contact with an outer bottom surface of the second housing 13.

The pressure sensor 41 is provided between the inner bottom surface of the first housing 20 and the outer bottom surface of the second housing 13. The pressure sensor 41 is of, for example, a laminated structure with a pressure-sensitive ink layer and two electrode layers. The pressure sensor 41 can measure a pressure applied thereto based on a change in contact resistance between the pressure-sensitive ink layer and the electrode layers, which change occurs due to deformation of the pressure sensor 41.

The display module 60 being pressed by a user's finger is moved downward as a whole. This deforms the pressure sensor 41. Based on this deformation, the magnitude of the pressure applied to the display module 60 can be measured. In this way, the display device 6 detects the magnitude of the pressure applied.

With the above operations, the display device 6 in accordance with Embodiment 2 enables (i) detection of a touch position on the cover glass 61 having the touch sensor and (ii) measurement of a touch pressure by the pressure sensor 41. Moreover, the display device 6 in accordance with Embodiment 2 can properly feed back to a user a vibration pattern corresponding to a contact position or touch pressure, similar to the display device 1 in accordance with Embodiment 1.

As the display panel 62 of the display device 6 in accordance with Embodiment 2, various types of display panels having different display modes, such as an OLED panel, can be employed. Also, in Embodiment 2, the touch sensor is provided in the cover glass 61, but the present invention is not limited to such a configuration. Embodiment 2 can employ an alternative configuration in which the touch sensor is provided in the display panel 12.

An aspect of the present invention is not limited to the above embodiments. The present invention also encompasses, in its technical scope, any embodiment derived by combining technical means disclosed in differing embodiments. Further, it is possible to form a new technical feature by combining the technical means disclosed in the respective embodiments.

[Recap]

A display device in accordance with a first aspect of the present invention includes:

a display module including a touch sensor; and

a first housing configured to house therein the display module,

the display module being provided with a vibrating element and being movably attached to the first housing.

In a second aspect of the present invention, a display device is configured such that the display module includes:

a display panel;

a second housing configured to house therein the display panel; and

a covering member adhered to a display surface of the display panel.

In a third aspect of the present invention, a display device is configured such that a first elastic member is provided in contact with the covering member and the first housing.

In a fourth aspect of the present invention, a display device is configured such that a second elastic member is provided in contact with the first housing and the second housing.

In a fifth aspect of the present invention, a display device is configured such that the vibrating element is provided in the covering member.

In a sixth aspect of the present invention, a display device is configured such that the touch sensor is provided in the display panel or the covering member.

In a seventh aspect of the present invention, a display device is configured such that a touch pressure is detected based on a change in capacitance between an electrode that functions as the touch sensor and an electrode provided on an inner bottom surface of the first housing.

In an eighth aspect of the present invention, a display device is configured such that a pressure sensor is provided between an inner bottom surface of the first housing and an outer bottom surface of the second housing, and the pressure sensor detects a touch pressure.

In a ninth aspect of the present invention, a display device is configured such that the vibrating element causes the covering member to vibrate in accordance with the touch pressure.

In a tenth aspect of the present invention, a display device is configured such that the covering member functions as an acoustically vibrating speaker.

In an eleventh aspect of the present invention, a display device is configured such that a groove is formed in an inner surface of the first housing, into which groove an end of the covering member is inserted, and

the first elastic member is provided on a lower surface of the groove.

In a twelfth aspect of the present invention, a display device is configured such that the second elastic member is provided on an inner bottom surface of the first housing.

### REFERENCE SIGNS LIST

1, 6 Display device

100, 200, 300 Display device (referential embodiment)

10, 60 Display module

11, 11A, 61 Cover glass

12, 62 Display panel

13, 63 Second housing

14 Common electrode layer

15 Vibrating element

20 First housing

21 Groove

30 First elastic body

31 Second elastic body

32 First plate spring

33 Second plate spring

40 Metal layer

1. A display device comprising:
a display module including a touch sensor; and
a first housing accommodating the display module,
the display module being provided with a vibrating element and being movably attached to the first housing.

2. The display device as set forth in claim 1, wherein the display module includes:
a display panel;
a second housing accommodating the display panel; and
a covering member adhered to a display surface of the display panel.

3. The display device as set forth in claim 2, wherein a first elastic member is provided in contact with the covering member and the first housing.

4. The display device as set forth in claim 2, wherein a second elastic member is provided in contact with the first housing and the second housing.

5. The display device as set forth in claim 2, wherein the vibrating element is provided in the covering member.

6. The display device as set forth in claim 2, wherein the touch sensor is provided in the display panel or the covering member.

7. The display device as set forth in claim 6, wherein a touch pressure is detected based on a change in capacitance between an electrode that functions as the touch sensor and an electrode provided on an inner bottom surface of the first housing.

8. The display device as set forth in claim 2, wherein a pressure sensor is provided between an inner bottom surface of the first housing and an outer bottom surface of the second housing, and the pressure sensor detects a touch pressure.

9. The display device as set forth in claim 7, wherein the vibrating element causes the covering member to vibrate in accordance with the touch pressure.

10. The display device as set forth in claim 5, wherein the covering member functions as an acoustically vibrating speaker.

11. The display device as set forth in claim 3, wherein a groove is provided in an inner surface of the first housing, into which groove an end portion of the covering member is inserted, and
the first elastic member is provided on a lower surface of the groove.

12. The display device as set forth in claim 4, wherein the second elastic member is provided on an inner bottom surface of the first housing.
